(19) United States
(12) Patent Application Publication
(10) Pub. No.: US 2011/0194895 A1
(43) Pub. Date: Aug. 11, 2011

(54) SAFETY CONNECTION ASSEMBLY FOR A CURTAIN CORD

(76) Inventor: Yung-Ching Lai, Singang Township (TW)

(21) Appl. No.: 12/840,247

(22) Filed: Jul. 20, 2010

(30) Foreign Application Priority Data
Feb. 5, 2010 (TW) 099202357

(51) Int. Cl. F16B 21/09

(52) U.S. Cl. 403/361

(57) ABSTRACT

A safety connection assembly for a curtain cord divided into two segments has a male connection member and a female connection member. The male connection member is securely mounted on one end of one segment and has an insert formed on one side thereof, and a protruding engagement part formed on an outer wall of the insert; the female connection member is securely mounted on one end of the other segment to be connected and has a cavity formed in one side thereof to hold and engage the insert of the male connection member, and a recessed engagement part annularly formed in an inner wall of the cavity. When a child's neck is strangled by the curtain cord, the male connection member and the female connection member can be easily detached from each other by the child or others when pulled by a force.

### BACKGROUND OF THE INVENTION

1. Field of the Invention

The present invention is related to a safety connection assembly for a curtain cord, and more particularly to a safety connection assembly adapted to a curtain cord, and facilitating a person to get rid of the curtain cord when the person's neck is strangled by the curtain cords in an accident.

2. Description of the Related Art

To easily fold or unfold curtains, conventional curtains, drapes or blinds are equipped with a cord retraction device. A flexible curtain cord is available in the cord retraction device for users to fold and expand the curtains, drapes or blinds by pulling the curtain cord.

When a child either inadvertently run in the neighborhood of the curtain cord or play with the curtain cord simply out of curiosity, tragic event oftentimes happens when child's neck is unfortunately entwined by the curtain cord and suffocated accordingly.

To circumvent such life-threatening danger caused by the curtain cord to children, the curtain cord used in curtains, drapes or blinds and capable of solving aforementioned problems must be provided without delay.

### SUMMARY OF THE INVENTION

An objective of the present invention is to provide a safety connection assembly for a curtain cord adapted to a curtain cords, and facilitating a person to get rid of the curtain cord when the person's neck is strangled by the curtain cord in an accident.

To achieve the foregoing objective, the safety connection assembly for a curtain cord that has a first segment and a second segment having an abutting end connected with an abutting end of the first segment, and the safety connection assembly has a male connection member and a female connection member.

The male connection member is adapted to be securely mounted on the abutting end of the first segment of the curtain cord, and has a male connection face, an insert and a protruding engagement part. The insert is formed on and protrudes from the male connection face and has an outer wall. The protruding engagement part is formed on the outer wall of the insert.

The female connection member is adapted to be securely mounted on the abutting end of the second segment, and has a female connection face, a cavity and a recessed engagement part. The female connection face faces the male connection surface. The cavity is formed in the female connection face to hold and engage the insert of the male connection member, and has an inner wall. The recessed engagement part is formed in the inner wall of the cavity and engages the protruding engagement part of the male connection member, whereby the recessed engagement part is detached from the protruding engagement part when the recessed engagement part and the protruding engagement part are pulled apart by a force.

A curtain cord divided into two segments can be connected by the male connection member and the female connection member of the safety connection assembly of the present invention. The male connection member and the female connection member are engaged by a simple and detachably engaging structure. When a child's neck is strangled by the curtain cord equipped with the safety connection assembly, as long as the child or others pulls the curtain cord apart with a force, the male connection member and the female connection member are disengaged mutually to free the child and preclude the chance of such life-threatening accident.

### BRIEF DESCRIPTION OF THE DRAWINGS

FIG. 1 is an exploded prospective view of a first embodiment of a safety connection assembly for a curtain cord in accordance with the present invention;

FIG. 2 is an exploded prospective view of a second embodiment of a safety connection assembly for a curtain cord in accordance with the present invention;

FIG. 3 is a side view in partial section of the safety connection assembly for a curtain cord in FIG. 1 or FIG. 2;

FIG. 4 is a side view in partial section of a third embodiment of a safety connection assembly for a curtain cord in accordance with the present invention;

FIG. 5 is an exploded side view in partial section of the safety connection assembly for a curtain cord in FIG. 1 adapted to a curtain cord having a plurality of beads before being connected;

FIG. 6 is a side view in partial section of the safety connection assembly for a curtain cord in FIG. 1 adapted to a curtain cord having a plurality of beads after being connected;

FIG. 7 is a side view of the safety connection assembly for a curtain cord in FIG. 1 adapted to a curtain cord having a plurality of beads and mounted around a curtain cord tensioning device; and

FIG. 8 is a front view of a roman shade having a curtain cord provided with the safety connection assemblies in FIG. 1.

### DETAILED DESCRIPTION OF THE INVENTION

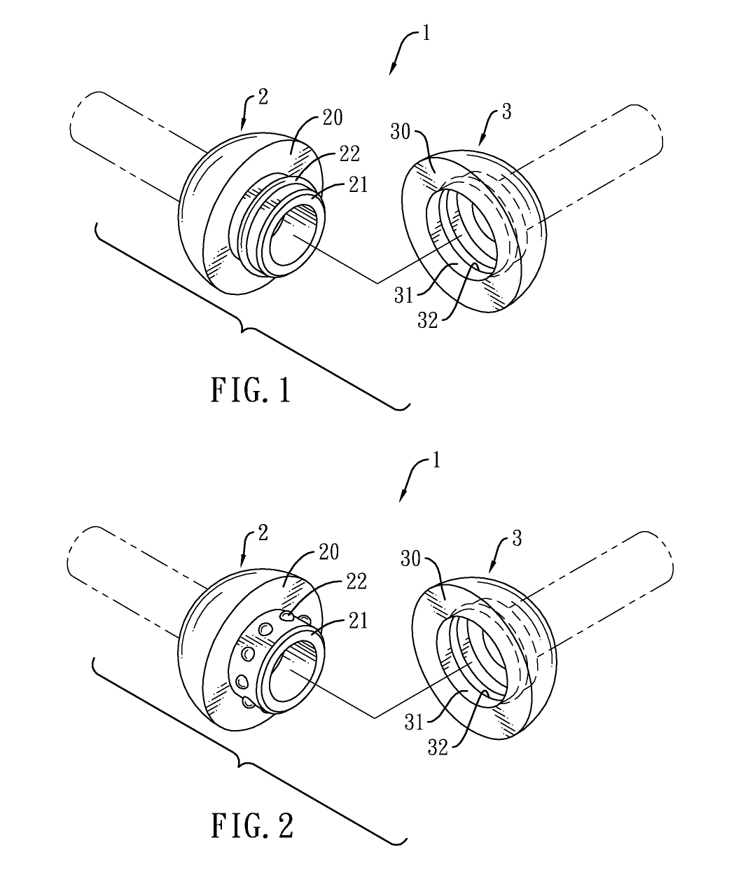

With reference to FIGS. 1 to 4, a safety connection assembly 1 for a curtain cord 4 in accordance with the present invention has a male connection member 2 and a female connection member 3. The curtain cord 4 is divided into a first segment and a second segment. The second segment has an abutting end connected with an abutting end of the first segment by the safety connection assembly 1.

The male connection member 2 is securely mounted on the abutting end of the first segment of the curtain cord 4, and has a male connection face 20, an insert 21 and a protruding engagement part 22, 22a. The insert 21 is tubular, is formed on and protrudes from the male connection face 20 and has an outer wall. The protruding engagement part 22 is formed on and protrudes from the outer wall of the insert 21, and may be an annular rib as shown in FIG. 1, a plurality of hemispherical bumps as shown in FIG. 2, or a plurality of conic projections as shown in FIG. 4.

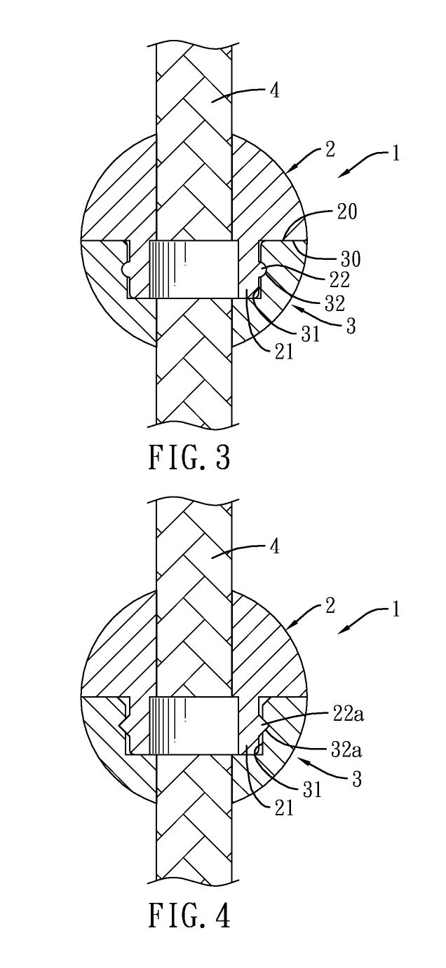

The female connection member 3 is securely mounted on the abutting end of the second segment, and has a female connection face 30, a cavity 31 and a recessed engagement part 32, 32a. The female connection face 30 faces to the male connection face 20. The cavity 31 is formed in the female connection face 30 to hold and engage the insert 21 of the male connection member 2 and has an inner wall. The recessed engagement part 32, 32a is formed in the inner wall of the cavity 31, and may be an annular groove in a hemispherical cross section as shown in FIG. 3 or in a triangular cross section as shown in FIG. 4.

The protruding engagement part 22, 22a of the male connection member 2 and the recessed engagement part 32, 32a of the female connection member 3 are detachably engaged and can be disengaged from each other with a separation force that is greater than the tightness between the protruding engagement part 22, 22a and the recessed engagement part 32, 32a. When a pulling force applied to the curtain cord 4 reaches the separation force, the engaged protruding engagement part 22, 22a and the recessed engagement part 32, 32a can be disengaged.

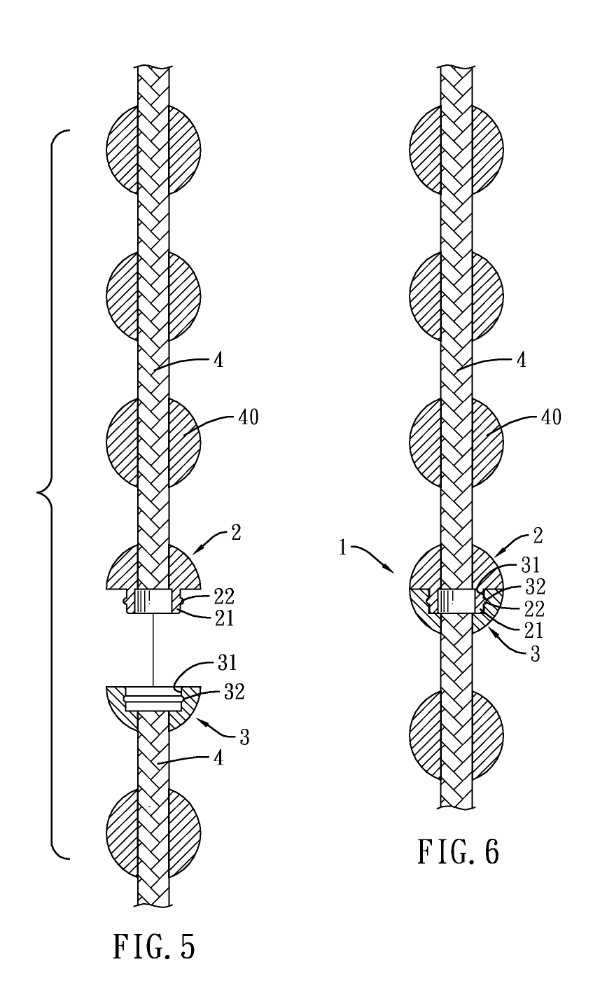

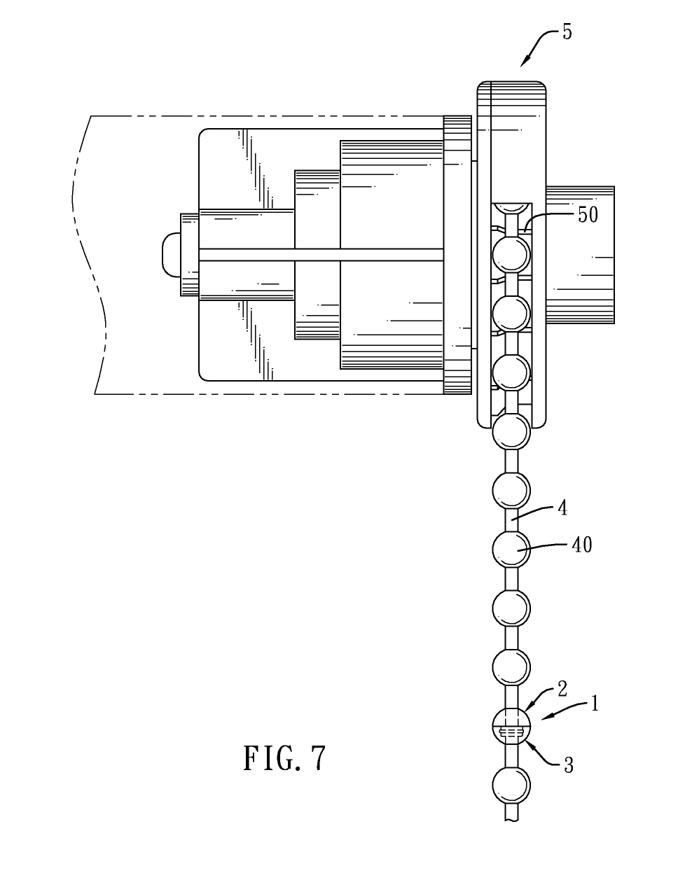

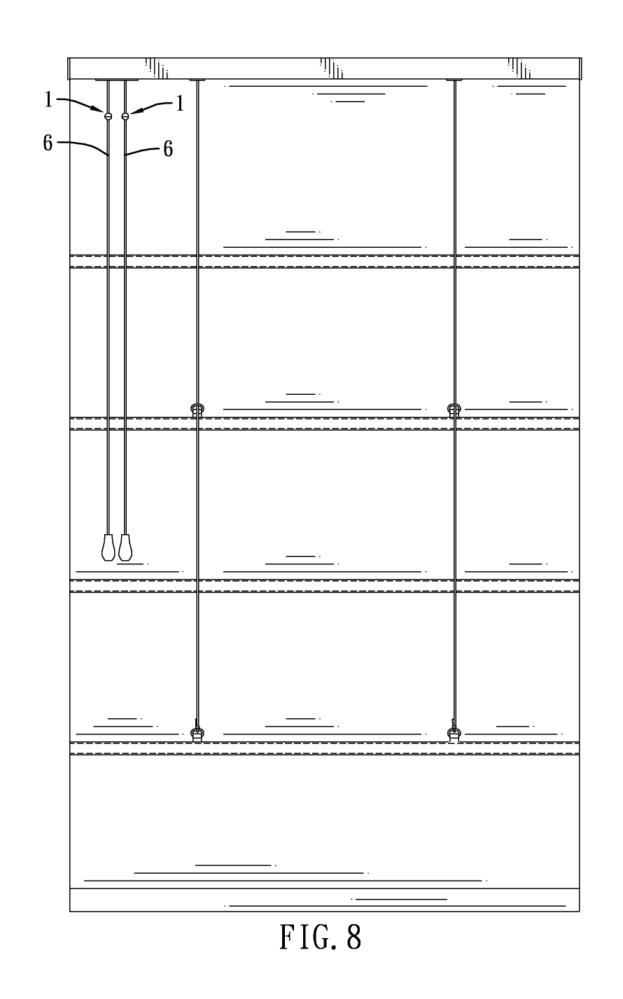

Regarding the use of the safety connection assembly, the safety connection assembly can be applied to curtain cords of curtains, drapes and blinds. With reference to FIGS. 5 to 7, the safety connection assembly can be applied to a curtain cord 4 that has a plurality of beads 40 separately mounted thereon for the purpose of engaging a retraction gear 50 in a curtain retraction device 5. The male connection member 2 and the female connection member 3 of the safety connection assembly 1 are hemispherical and are integrated to take a form consistent with that of the beads so that the safety connection assembly 1 and the beads can drive the retraction gear 50 to draw or drop the curtain.

With reference to FIGS. 1 and 8, the safety connection assembly 1 is mounted on a curtain cord 6 of a roman shade. The curtain cord 6 is divided into an upper segment and a lower segment. The male connection member 2 and the female connection member 3 are respectively and securely mounted on two corresponding ends of the upper and lower segments to connect the two segments together. By the connection of the male connection member 2 and the female connection member 3, the two segments are connected with each other to form a curtain cord 6 for folding or expanding the curtain.

The male connection member 2 and the female connection member 3 of the safety connection assembly are engaged each other with an easily and detachably engaging structure including protruding engagement part 22 and recessed engagement part 32. When a child's neck is strangled by the curtain cord 4,6, the segments of the curtain cord 4,6 can be easily detached from each other with a separation force caused by a struggling force by the strangled child or a pulling force applied to the curtain cord by others. Accordingly, the child can get out of the strangling situation by himself/herself or by the assistance of others easily so as to avoid an accident occurring.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A safety connection assembly for a curtain cord that has a first segment and a second segment having an abutting end connected with an abutting end of the first segment, and the safety connection assembly comprising:
a male connection member adapted to be securely mounted on the abutting end of the first segment of the curtain cord, and having:
a male connection face;
an insert formed on and protruding from the male connection face and having an outer wall; and
a protruding engagement part formed on the outer wall of the insert; and
a female connection member adapted to be securely mounted on the abutting end of the second segment, and having:
a female connection face facing the male connection surface;
a cavity formed in the female connection face to hold and engage the insert of the male connection member, and having an inner wall; and
a recessed engagement part formed in the inner wall of the cavity and engaging the protruding engagement part of the male connection member, whereby the recessed engagement part is detached from the protruding engagement part when the recessed engagement part and the protruding engagement part are pulled apart by a force.

2. The safety connection assembly for a curtain cord as claimed in claim 1, wherein the protruding engagement part is an annular rib, and the recessed engagement part is an annular groove in a hemispherical cross section.

3. The safety connection assembly for a curtain cord as claimed in claim 1, wherein the protruding engagement part is a plurality of hemispherical bumps, and the recessed engagement part is an annular groove in a hemispherical cross section.

4. The safety connection assembly for a curtain cord as claimed in claim 1, wherein the engagement part is a plurality of conic projections, and the recessed engagement part is an annular groove in a triangular cross section.
